(19) United States
(12) Patent Application Publication
(10) Pub. No.: US 2009/0272823 A1
(43) Pub. Date: Nov. 5, 2009

(54) METHOD FOR CONTROLLING A FUEL INJECTION APPARATUS

(76) Inventors: Frank Atzler, Dettenhofen (DE); Oliver Kastner, Donaustauf (DE); Andreas Weigand, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/438,442

(22) PCT Filed: Aug. 17, 2007
(86) PCT No.: PCT/EP07/58573

§ 371 Date: Feb. 23, 2009

(30) Foreign Application Priority Data
Aug. 23, 2006 (DE) 10 2006 039 523.9

(51) Int. Cl. F02M 61/16; B05B 1/30

(52) U.S. Cl. 239/533.6; 239/584

(57) ABSTRACT

The invention relates to a method for controlling a fuel injection apparatus, in particular a piezoelectric injector. Here, the fuel quantity which is injected into the combustion chamber is set by a mechanically actuable injector needle (1). Here, the injected fuel quantity depends on the pressure difference which can be set by the injector needle (1) between the spray-hole inlet and the spray-hole outlet.

The invention relates to a method for controlling a fuel injection apparatus according to the features of the preamble of main claim 1.

Fuel injection apparatuses for operating an internal combustion engine have generally been known for many years. In the case of a so-called common rail injection system, the fuel supply into the respective combustion chamber of the internal combustion engine takes place by means of injectors. Different properties for different driving conditions are conveyed by these systems in order to ensure pollutant emission limits, fuel consumption minimization and also longevity of the system and thus of the motor vehicle. It has proven effective, above all in the partial-load operational range, to positively influence the fuel-mixture generation by way of one or several preinjections and thus to improve the emission.

The demand for injector geometry is conflictive for the rated power output and partial load. Injectors with high flow values for high outputs are disadvantageous for a good fuel-mixture generation in the partial load. A wetting of the wall is also to be avoided in the case of injections well upstream or downstream of the dead center.

It is known from the prior art to be able to prevent wall deposits by way of small preinjection quantities at short temporal intervals in respect of the main injection. In this way, the minimal quantity which can be injected and the penetration depth thereof into the combustion chamber are subjected like before to certain limits which depend on the injection pressure.

The object underlying the present invention consists in providing a method which enables a more precise dosing of the injection quantity, a minimization of the injection quantity and at the same time the ability to repeat the injection process.

This object is achieved in accordance with the invention by the features of claim 1. Advantageous configurations of the invention are characterized in the subclaims.

The advantages achieved with the invention consist in particular in it being possible to realize different injection pressures. The fuel quantity injected into the combustion chamber and the atomization thereof depend directly on the pressure difference between the spray hole inlet and the spray hole outlet and not directly on the system pressure in the supply line of the injector.

The injection pressures can be varied in this way by the controlled injector needle for each individual injection, and also in the event of multiple injections. Here the spray hole inlet pressure can be set to certain limits by way of the throttling on the nozzle seat of the injection valve. These limits are set on the one side by the maximally possible needle travel, on the other side by the cavitation developing on the nozzle seat and the wear associated therewith, which is dependent on the material used. The spray hole inlet pressure depends here on the opening cross-section of the throttle gap. The greater this opening cross-section, the greater the spray hole inlet pressure.

The throttle gap is adjusted by way of an adjustable travel of the injector needle. It has proven advantageous here to directly mechanically control the injector needles. The controllable needle travel determines the spray hole inlet pressures and as a result enables the jet penetration depth as well as the mixture-fuel formation to be individually optimized for each injection. This is advantageous since a wetting of the cylinder wall with fuel can as a result be prevented both in the case of very early as well as very late injections with fuel. Furthermore, the reduced spray hole inlet pressure in the blind hole allows pressure oscillations in the injection system to be compensated, said pressure oscillations being caused by multiple injections. New injection curve shapes, like for instance boot or ramp, are also possible as a result of the controllable seat throttling.

The control of the needle travel also influences the flow conditions within the blind hole so that a cleaning of the spray hole is enabled as a result of the increase in turbulences or cavitation in the spray hole. Furthermore, a higher atomization of the fuel in the combustion chamber and thus an improved fuel-mixture formation is also enabled as a result of the high turbulence within the blind hole.

Details of the invention are explained in more detail with reference to the drawing, in which;

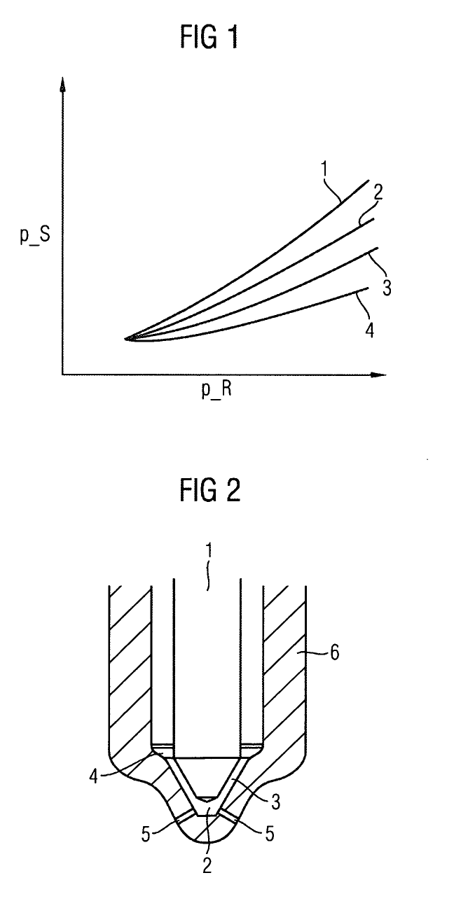

FIG. 1 shows the pressure curve on the spray hole inlet as a function of the rail pressure with different needle travels,

FIG. 2 shows a schematic diagram of an injector, in particular of the blind hole with injector needle

FIG. 1 shows the pressure curve on the spray hole as a function of the rail pressure with 4 different needle travels.

The spray hole inlet pressure p_S is plotted in the vertical direction and the rail pressure p_R is plotted in the horizontal direction. Furthermore, the curve courses 1 to 4 also show the respective course for different needle travel values. Curve 1 corresponds here to the largest and curve 4 to the smallest needle travel.

The spray hole inlet pressure p_S is greater, the greater the needle travel. However, it is lower than the rail pressure p_R at the same point in time.

FIG. 2 shows a schematic diagram of an injector, in particular of the blind hole with injector needle. The injector consists in this representation of an injector needle 1, which is driven mechanically (not shown in the drawing), a blind hole 2 and at least one outlet opening 5 into the combustion chamber. An adjustable throttle gap 3 forms between the inner wall 6 of the injector and the injector needle 1. The system pressure existing on the rail (not shown in the drawing) prevails in the fuel supply line 4.

The injector needle 1 is now preferably mechanically driven. By way of example, the injector needle moves vertically downwards. As a result of this downward movement, the opening cross-section of the throttle gap 3 reduces. In this way, the rail pressure in the fuel supply line 4 always remains approximately constant. By contrast the spray hole inlet pressure reduces with an ever smaller opening cross-section of the throttle gap 3. The fuel is now injected into the combustion chamber (not shown in the drawing) by way of the outlet opening 5. In this way, the fuel injection quantity into the combustion chamber is greater, the greater the pressure difference between the spray hole inlet and the spray hole outlet.

1. A method for controlling a fuel injection apparatus, using an injector, having a spray hole and an injector blind hole, as well as an injector needle, which defines a throttle gap with an inner wall of the injector, the latter being defined by the injector needle of the injector and the inner wall of the injector,
characterized in that
the injector needle for adjustably changing the opening cross-section of the throttle gap is controlled such that a defined spray hole inlet pressure is achieved within a certain limit range.

2. The method as claimed in claim 1, characterized in that the limit range of the spray hole inlet pressure is determined by the needle travel and/or cavitation and/or material quality.

3. The method as claimed in claim 1 or 2, characterized in that the injector needle is directly mechanically driven.
